(19) United States
(12) Patent Application Publication
(10) Pub. No.: US 2023/0368409 A1
(43) Pub. Date: Nov. 16, 2023

(54) STORAGE MEDIUM, MODEL TRAINING METHOD, AND MODEL TRAINING DEVICE

(71) Applicant: Fujitsu Limited, Kawasaki-shi (JP)

(72) Inventor: Akiyoshi UCHIDA, Akashi (JP)

(73) Assignee: Fujitsu Limited, Kawasaki-shi (JP)

(21) Appl. No.: 18/181,866

(22) Filed: Mar. 10, 2023

(30) Foreign Application Priority Data
May 13, 2022 (JP) 2022-079723

(51) Int. Cl. G06T 7/70; G06T 7/254

(52) U.S. Cl. CPC G06T 7/70; G06T 7/254; G06T 2207/20081; G06T 2207/30204; G06T 2207/20224; G06T 2207/30201

(57) ABSTRACT

A storage medium storing a model training program that causes a computer to execute a process that includes acquiring a plurality of images which include a face of a person with a marker; changing an image size of the plurality of images to first size; specifying a position of the marker included in the changed plurality of images; generating a label based on difference corresponding to a degree of movement of a facial part that forms facial expression of the face; correcting the generated label based on relationship between each of the changed plurality of images and a second image; generating training data by attaching the corrected label to the changed plurality of images; and training, by using the training data, a machine learning model that outputs a degree of movement of a facial part of third image by inputting the third image.

### CROSS-REFERENCE TO RELATED APPLICATION

This application is based upon and claims the benefit of priority of the prior Japanese Patent Application No. 2022-79723, filed on May 13, 2022, the entire contents of which are incorporated herein by reference.

### FIELD

The embodiments discussed herein are related to a storage medium, a model training method, and a model training device.

### BACKGROUND

Facial expressions play an important role in nonverbal communication. Technology for estimating facial expressions is important to understand and sense people. A method called an action unit (AU) has been known as a tool for estimating facial expressions. The AU is a method for separating and quantifying facial expressions based on facial parts and facial expression muscles.

An AU estimation engine is based on machine learning based on a large volume of training data, and image data of facial expressions and Occurrence (presence/absence of occurrence) and Intensity (occurrence intensity) of each AU are used as training data. Furthermore, Occurrence and Intensity of the training data are subjected to Annotation by a specialist called a Coder.

When generation of the training data is entrusted to the annotation by the coder or the like in this way, it takes cost and time. Therefore, there is an aspect in which it is difficult to generate a large volume of training data. From such an aspect, a generation device has been proposed that generates training data for AU estimation.

For example, the generation device specifies a position of a marker included in a captured image including a face, and determines an AU intensity based on a movement amount from a marker position in an initial state, for example, an expressionless state. On the other hand, the generation device generates a face image by extracting a face region from the captured image and normalizing an image size. Then, the generation device generates training data for machine learning by attaching a label including the AU intensity or the like to the generated face image.

Japanese Laid-open Patent Publication No. 2012-8949, International Publication Pamphlet No. WO 2022/024272, U.S. Patent Application Publication No. 2021/0271862, and U.S. Patent Application Publication No. 2019/0294868 are disclosed as related art.

### SUMMARY

According to an aspect of the embodiments, a non-transitory computer-readable storage medium storing a model training program that causes at least one computer to execute a process, the process includes acquiring a plurality of images which include a face of a person, the plurality of images including a marker; changing an image size of the plurality of images to first size; specifying a position of the marker included in the changed plurality of images for each of the changed plurality of images; generating a label for each of the changed plurality of images based on difference between the position of the marker included in each of the changed plurality of images and first position of the marker included in a first image of the changed plurality of images, the difference corresponding to a degree of movement of a facial part that forms facial expression of the face; correcting the generated label based on relationship between each of the changed plurality of images and a second image of the changed plurality of images; generating training data by attaching the corrected label to the changed plurality of images; and training, by using the training data, a machine learning model that outputs a degree of movement of a facial part of third image by inputting the third image.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an operation example of a system;

FIG. 2 is a diagram illustrating exemplary arrangement of cameras;

FIG. 3 is a schematic diagram illustrating a processing example of a captured image;

FIG. 4 is a schematic diagram illustrating one aspect of a problem;

FIG. 5 is a block diagram illustrating a functional configuration example of a training data generation device;

FIG. 6 is a diagram for explaining an example of a movement of a marker;

FIG. 7 is a diagram for explaining a method of determining occurrence intensity;

FIG. 8 is a diagram for explaining an example of the method of determining the occurrence intensity;

FIG. 9 is a diagram for explaining an example of a method of creating a mask image;

FIG. 10 is a diagram for explaining an example of the method of creating the mask image;

FIG. 11 is a schematic diagram illustrating an imaging example of a subject;

FIG. 12 is a schematic diagram illustrating an imaging example of the subject;

FIG. 13 is a schematic diagram illustrating an imaging example of the subject;

FIG. 14 is a schematic diagram illustrating an imaging example of the subject;

FIG. 15 is a flowchart illustrating a procedure of overall processing;

FIG. 16 is a flowchart illustrating a procedure of determination processing;

FIG. 17 is a flowchart illustrating a procedure of image process processing;

FIG. 18 is a flowchart illustrating a procedure of correction processing;

FIG. 19 is a schematic diagram illustrating an example of a camera unit;

FIG. 20 is a diagram illustrating a training data generation case;

FIG. 21 is a diagram illustrating a training data generation case;

FIG. 22 is a schematic diagram illustrating an imaging example of the subject;

FIG. 23 is a diagram illustrating an example of a corrected face image;

FIG. 24 is a diagram illustrating an example of the corrected face image;

FIG. 25 is a flowchart illustrating a procedure of correction processing to be applied to a camera other than a reference camera; and

FIG. 26 is a diagram illustrating a hardware configuration example.

### DESCRIPTION OF EMBODIMENTS

With the generation device described above, in a case where the same marker movement amount is imaged, whereas a gap is generated in the movement of the marker between the processed face images through processing such as extraction or normalization on the captured image, a label with the same AU intensity is attached to each face image. In this way, in a case where training data in which a correspondence relationship between the marker movement over the face image and the label is distorted is used for machine learning, an estimated value of an AU intensity output by a machine learning model to which a captured image obtained by imaging a similar facial expression change is input varies. Therefore, AU estimation accuracy is deteriorated.

In one aspect, an object of the embodiment is to provide a training data generation program, a training data generation method, and a training data generation device that can prevent generation of training data in which a correspondence relationship between a marker movement over a face image and a label is distorted.

Hereinafter, embodiments of a training data generation program, a training data generation method, and a training data generation device according to the present application will be described with reference to the accompanying drawings. Each of the embodiments merely describes an example or aspect, and such exemplification does not limit numerical values, a range of functions, usage scenes, and the like. Then, each of the embodiments may be appropriately combined within a range that does not cause contradiction between pieces of processing content.

### First Embodiment

<System Configuration>

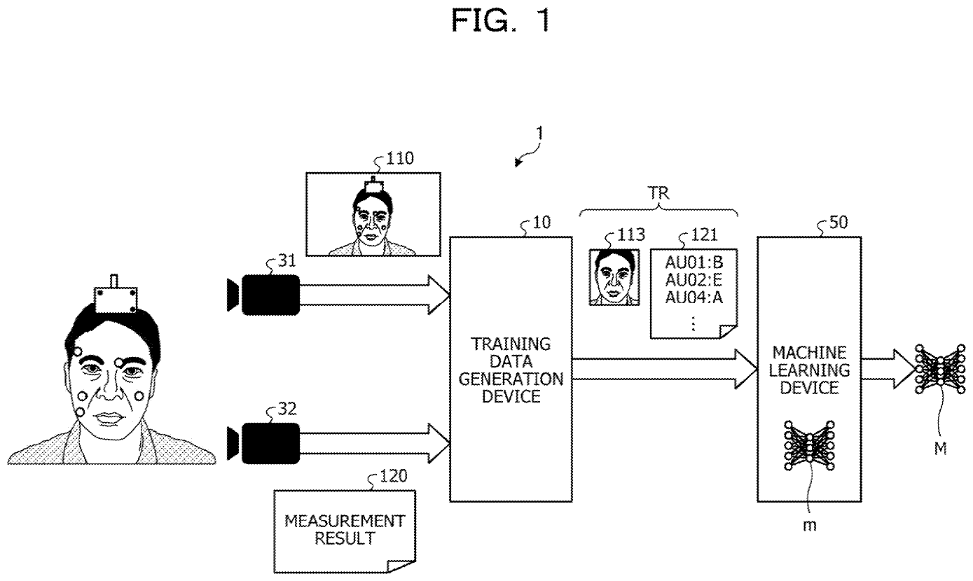

FIG. 1 is a schematic diagram illustrating an operation example of a system. As illustrated in FIG. 1, a system 1 may include an imaging device 31, a measurement device 32, a training data generation device 10, and a machine learning device 50.

The imaging device 31 may be implemented by a red, green, and blue (RGB) camera or the like, only as an example. The measurement device 32 may be implemented by an infrared (IR) camera or the like, only as an example. In this manner, the imaging device 31 has spectral sensitivity corresponding to visible light and also has spectral sensitivity corresponding to infrared light, only as an example. The imaging device 31 and the measurement device 32 may be arranged in a state of facing a face of a person with a marker. Hereinafter, it is assumed that the person whose face is marked be an imaging target, and there is a case where the person who is the imaging target is described as a “subject”.

When imaging by the imaging device 31 and measurement by the measurement device 32 are performed, the subject changes facial expressions. As a result, the training data generation device 10 can acquire how the facial expression changes in chronological order as a captured image 110. Furthermore, the imaging device 31 may capture a moving image as the captured image 110. Such a moving image can be regarded as a plurality of still images arranged in chronological order. Furthermore, the subject may change the facial expression freely, or may change the facial expression according to a predetermined scenario.

The marker is implemented by an IR reflective (retroreflective) marker, only as an example. Using the IR reflection with such a marker, the measurement device 32 can perform motion capturing.

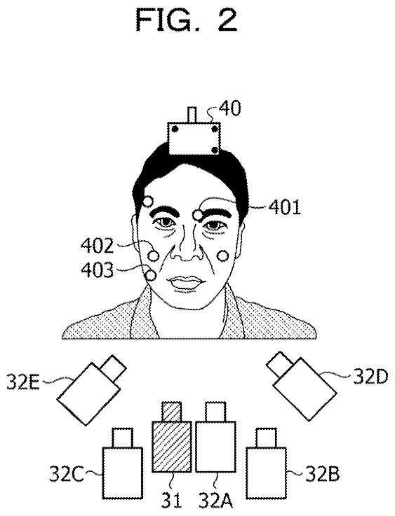

FIG. 2 is a diagram illustrating exemplary arrangement of cameras. As illustrated in FIG. 2, the measurement device 32 is implemented by a marker tracking system using a plurality of IR cameras 32A to 32E. According to such a marker tracking system, a position of the IR reflective marker can be measured through stereo imaging. A relative positional relationship of these IR cameras 32A to 32E can be corrected in advance by camera calibration. Note that, although an example in which five camera units that are the IR cameras 32A to 32E are used for the marker tracking system is illustrated in FIG. 2, any number of IR cameras may be used for the marker tracking system.

Furthermore, a plurality of markers is attached to the face of the subject so as to cover target AUs (for example, AU 1 to AU 28). Positions of the markers change according to a change in a facial expression of the subject. For example, a marker 401 is arranged near the root of the eyebrow. Furthermore, a marker 402 and a marker 403 are arranged near the nasolabial line. The markers may be arranged over the skin corresponding to movements of one or more AUs and facial expression muscles. Furthermore, the markers may be arranged to exclude a position on the skin where a texture change is larger due to wrinkles or the like. Note that the AU is a unit forming the facial expression of the person's face.

Moreover, an instrument 40 to which a reference point marker is attached is worn by the subject. It is assumed that a position of the reference point marker attached to the instrument 40 do not change even when the facial expression of the subject changes. Accordingly, the training data generation device 10 can measure a positional change of the markers attached to the face based on a positional change of a relative position from the reference point marker. By setting the number of such reference markers to be equal to or more than three, the training data generation device 10 can specify a position of a marker in a three-dimensional space.

The instrument 40 is, for example, a headband, and the reference point marker is arranged outside the contour of the face. Furthermore, the instrument 40 may be a virtual reality (VR) headset, a mask made of a hard material, or the like. In that case, the training data generation device 10 can use a rigid surface of the instrument 40 as the reference point marker.

According to the marker tracking system implemented by using the IR cameras 32A to 32E and the instrument 40, it is possible to specify the position of the marker with high accuracy. For example, the position of the marker over the three-dimensional space can be measured with an error equal to or less than 0.1 mm.

According to such a measurement device 32, it is possible to obtain not only the position of the marker or the like, but also a position of the head of the subject over the three-dimensional space or the like as a measurement result 120. Hereinafter, a coordinate position over the three-dimensional space may be described as a “3D position”.

The training data generation device 10 provides a training data generation function for generating training data, to which a label including an AU occurrence intensity or the like is added, to a training face image 113 that is generated from the captured image 110 in which the face of the subject is imaged. Only as an example, the training data generation device 10 acquires the captured image 110 imaged by the imaging device 31 and the measurement result 120 measured by the measurement device 32. Then, the training data generation device 10 determines an occurrence intensity 121 of an AU corresponding to the marker based on a marker movement amount obtained as the measurement result 120.

The “occurrence intensity” here may be, only as an example, data in which intensity of occurrence of each AU is expressed on a five-point scale of A to E and annotation is performed as “AU 1:2, AU 2:5, AU 4:1, . . . ”. Note that the occurrence intensity is not limited to be expressed on the five-point scale, and may be expressed on a two-point scale (whether or not to occur), for example. In this case, only as an example, while it may be expressed as “occurred” when the evaluation result is two or more out of the five-point scale, it may be expressed as “not occurred” when the evaluation result is less than two.

Along with the determination of the AU occurrence intensity 121, the training data generation device 10 performs processes such as extracting a face region, normalizing an image size, or removing a marker in an image, on the captured image 110 imaged by the imaging device 31. As a result, the training data generation device 10 generates the training face image 113 from the captured image 110.

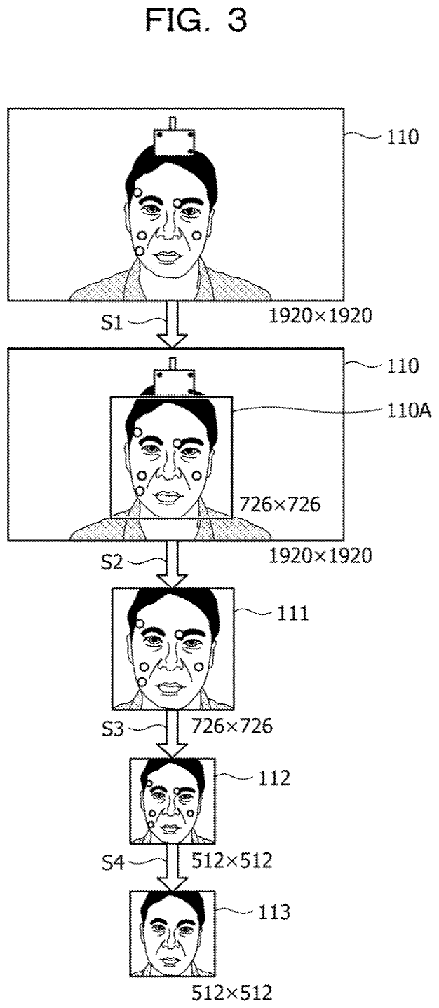

FIG. 3 is a schematic diagram illustrating a processing example of a captured image. As illustrated in FIG. 3, face detection is performed on the captured image 110 (S1). As a result, a face region 110A of 726 vertical pixels×726 horizontal pixels is detected from the captured image 110 of 1920 vertical pixels×1080 horizontal pixels. A partial image corresponding to the face region 110A detected in this way is extracted from the captured image 110 (S2). As a result, an extracted face image 111 of 726 vertical pixels×726 horizontal pixels is obtained.

The extracted face image 111 is generated in this way because this is effective in the following points. As one aspect, the marker is merely used to determine the occurrence intensity of the AU that is the label to be attached to training data and is deleted from the captured image 110 so as not to affect the determination on an AU occurrence intensity by a machine learning model m. At the time of the deletion of the marker, the position of the marker existing over the image is searched. However, in a case where a search region is narrowed to the face region 110A, a calculation amount can be reduced by several times to several ten times than a case where the entire captured image 110 is set as the search region. As another aspect, in a case where a dataset of training data TR is stored, it is not necessary to store an unnecessary region other than the face region 110A. For example, in an example of a training sample illustrated in FIG. 3, an image size can be reduced from the captured image 110 of 1920 vertical pixels×1080 horizontal pixels to the extracted face image 111 of 726 vertical pixels×726 horizontal pixels.

Thereafter, the extracted face image 111 is resized to an input size of a width and a height that is equal to or less than a size of an input layer of the machine learning model m, for example, a convolved neural network (CNN). For example, when it is assumed that the input size of the machine learning model m be 512 vertical pixels×512 horizontal pixels, the extracted face image 111 of 726 vertical pixels×726 horizontal pixels is normalized to an image size of 512 vertical pixels×512 horizontal pixels (S3). As a result, a normalized face image 112 of 512 vertical pixels×512 horizontal pixels is obtained. Moreover, the markers are deleted from the normalized face image 112 (S4). As a result of steps S1 to S4, a training face image 113 of 512 vertical pixels×512 horizontal pixels is obtained.

In addition, the training data generation device 10 generates a dataset including the training data TR in which the training face image 113 is associated with the occurrence intensity 121 of the AU assumed to be a correct answer label. Then, the training data generation device 10 outputs the dataset of the training data TR to the machine learning device 50.

The machine learning device 50 provides a machine learning function for performing machine learning using the dataset of the training data TR output from the training data generation device 10. For example, the machine learning device 50 trains the machine learning model m according to a machine learning algorithm, such as deep learning, using the training face image 113 as an explanatory variable of the machine learning model m and using the occurrence intensity 121 of the AU assumed to be a correct answer label as an objective variable of the machine learning model m. As a result, a machine learning model M that outputs an estimated value of an AU occurrence intensity is generated using a face image obtained from a captured image as an input.

<One Aspect of Problem>

As described in the background above, in a case where the processing on the captured image described above is performed, there is an aspect in which training data in which a correspondence relationship between a movement of a marker over a face image and a label is distorted is generated.

As a case where the correspondence relationship is distorted in this way, a case where the sizes of the subject's faces are individually different, a case where the same subject is imaged from different imaging positions, or the like are exemplified. In these cases, even in a case where the same movement amount of the marker is observed, the extracted face image 111 with a different image size is extracted from the captured image 110.

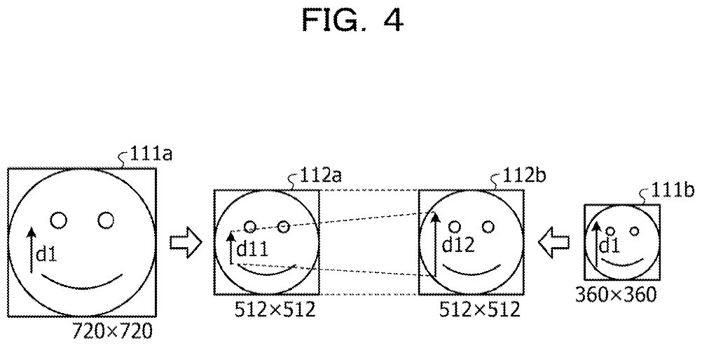

FIG. 4 is a schematic diagram illustrating one aspect of a problem. In FIG. 4, an extracted image 111a and an extracted face image 111b extracted from two captured images in which the same marker movement amount d is imaged are illustrated. Note that it is assumed that the extracted image 111a and the extracted face image 111b be captured with a distance between an optical center of the imaging device 31 and the face of the subject.

As illustrated in FIG. 4, the extracted image 111a is a partial image obtained by extracting a face region of 720 vertical pixels×720 horizontal pixels from a captured image in which a subject a with a large face is imaged. On the other hand, the extracted face image 111b is a partial image obtained by extracting a face region of 360 vertical pixels×360 horizontal pixels from a captured image in which a subject b with a small face is imaged.

The extracted image 111a and the extracted face image 111b are normalized to an image size of 512 vertical pixels×512 horizontal pixels that is the size of the input layer of the machine learning model m. As a result, in a normalized face image 112a, the marker movement amount is reduced from d1 to d11 (<d1). As a result, in a normalized face image 112b, the marker movement amount is enlarged from d1 to d12 (>d1). In this way, a gap in the marker movement amount is generated between the normalized face image 112a and the normalized face image 112b.

On the other hand, for both of the subject a and the subject b, the same marker movement amount d1 is obtained as the measurement result 120 by the measurement device 32. Therefore, the same AU occurrence intensity 121 is attached to the normalized face images 112a and 112b as a label.

As a result, in a training face image corresponding to the normalized face image 112a, a marker movement amount over the training face image is reduced to d11 smaller than the actual measurement value d1 by the measurement device 32. On the other hand, an AU occurrence intensity corresponding to the actual measurement value d1 is attached to the correct answer label. In addition, in a training face image corresponding to the normalized face image 112b, a marker movement amount over the training face image is enlarged to d12 larger than the actual measurement value d1 by the measurement device 32. On the other hand, the AU occurrence intensity corresponding to the actual measurement value d1 is attached to the correct answer label.

In this way, from the normalized face images 112a and 112b, training data in which a correspondence relationship between a marker movement over a face image and a label is distorted may be generated. Note that, here, a case where the size of the face of the subject is individually different has been described as an example. However, in a case where the same subject is imaged from the imaging positions with different distances from the optical center of the imaging device 31, the similar problem may occur.

<One Aspect of Problem Solving Approach>

Therefore, the training data generation function according to the present embodiment corrects a label of an AU occurrence intensity corresponding to the marker movement amount measured by the measurement device 32, based on a distance between the optical center of the imaging device 31 and the head of the subject or a face size over the captured image.

As a result, it is possible to correct the label in accordance with the movement of the marker over the face image that is fluctuated by processing such as extraction of a face region or normalization of an image size.

Therefore, according to the training data generation function according to the present embodiment, it is possible to prevent generation of the training data in which the correspondence relationship between the movement of the marker over the face image and the label is distorted.

<Configuration of Training Data Generation Device 10>

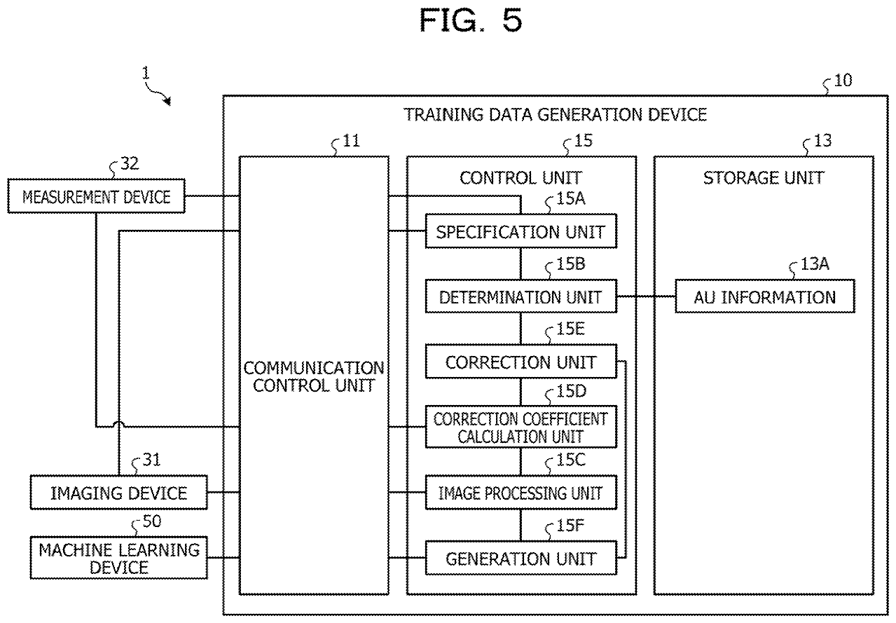

FIG. 5 is a block diagram illustrating a functional configuration example of the training data generation device 10. In FIG. 5, blocks related to the machine learning functions of the training data generation device 10 are schematically illustrated. As illustrated in FIG. 5, the training data generation device 10 includes a communication control unit 11, a storage unit 13, and a control unit 15. Note that, in FIG. 1, only functional units related to the training data generation functions described above are excerpted and illustrated. Functional units other than those illustrated may be included in the training data generation device 10.

The communication control unit 11 is a functional unit that controls communication with other devices, for example, the imaging device 31, the measurement device 32, the machine learning device 50, or the like. For example, the communication control unit 11 may be implemented by a network interface card such as a local area network (LAN) card. As one aspect, the communication control unit 11 receives the captured image 110 imaged by the imaging device 31 and the measurement result 120 measured by the measurement device 32. As another aspect, the communication control unit 11 outputs a dataset of training data in which the training face image 113 is associated with the occurrence intensity 121 of the AU assumed to be the correct answer label, to the machine learning device 50.

The storage unit 13 is a functional unit that stores various types of data. Only as an example, the storage unit 13 is implemented by an internal, external or auxiliary storage of the training data generation device 10. For example, the storage unit 13 can store various types of data such as AU information 13A representing a correspondence relationship between a marker and an AU or the like. In addition to such AU information 13A, the storage unit 13 can store various types of data such as a camera parameter of the imaging device 31 or a calibration result.

The control unit 15 is a processing unit that controls the entire training data generation device 10. For example, the control unit 15 is implemented by a hardware processor. In addition, the control unit 15 may be implemented by hard-wired logic. As illustrated in FIG. 5, the control unit 15 includes a specification unit 15A, a determination unit 15B, an image processing unit 15C, a correction coefficient calculation unit 15D, a correction unit 15E, and a generation unit 15F.

The specification unit 15A is a processing unit that specifies a position of a marker included in a captured image. The specification unit 15A specifies the position of each of the plurality of markers included in the captured image. Moreover, in a case where a plurality of images is acquired in chronological order, the specification unit 15A specifies a position of a marker for each image. The specification unit 15A can specify the position of the marker over the captured image in this way and can also specify planar or spatial coordinates of each marker, for example, a 3D position, based on a positional relationship with the reference marker attached to the instrument 40. Note that the specification unit 15A may determine the positions of the markers from a reference coordinate system, or may determine them from a projection position of a reference plane.

The determination unit 15B is a processing unit that determines whether or not each of the plurality of AUs has occurred based on an AU determination criterion and the positions of the plurality of markers. The determination unit 15B determines an occurrence intensity for one or more occurring AUs among the plurality of AUs. At this time, in a case where an AU corresponding to the marker among the plurality of AUs is determined to occur based on the determination criterion and the position the marker, the determination unit 15B may select the AU corresponding to the marker.

For example, the determination unit 15B determines an occurrence intensity of a first AU based on a movement amount of a first marker calculated based on a distance between a reference position of the first marker associated with a first AU included in the determination criterion and a position of the first marker specified by the specification unit 15A. Note that, it may be said that the first marker is one or a plurality of markers corresponding to a specific AU.

The AU determination criterion indicates, for example, one or a plurality of markers used to determine an AU occurrence intensity for each AU, among the plurality of markers. The AU determination criterion may include reference positions of the plurality of markers. The AU determination criterion may include, for each of the plurality of AUs, a relationship (conversion rule) between an occurrence intensity and a movement amount of a marker used to determine the occurrence intensity. Note that the reference positions of the markers may be determined according to each position of the plurality of markers in a captured image in which the subject is in an expressionless state (no AU has occurred).

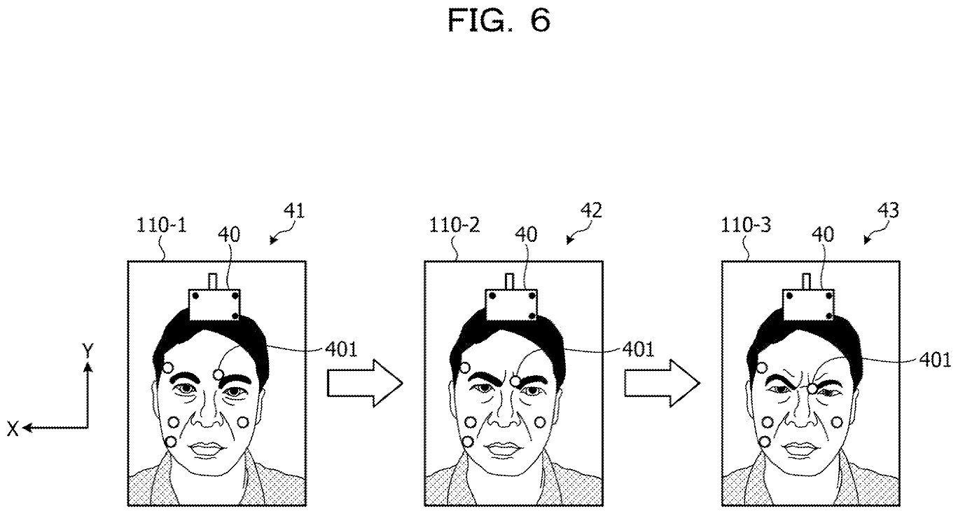

Here, a movement of a marker will be described with reference to FIG. 6. FIG. 6 is a diagram for explaining an example of the movement of the marker. References 110-1 to 110-3 in FIG. 6 are captured images imaged by an RGB camera corresponding to one example of the imaging device 31. Furthermore, it is assumed that the captured images be captured in order of the references 110-1, 110-2, and 110-3. For example, the captured image 110-1 is an image when the subject is expressionless. The training data generation device 10 can regard a position of a marker in the captured image 110-1 as a reference position where a movement amount is zero.

As illustrated in FIG. 6, the subject has a facial expression of drawing his/her eyebrows. At this time, a position of the marker 401 moves downward in accordance with the change in the facial expression. At that time, a distance between the position of the marker 401 and the reference marker attached to the instrument 40 increases.

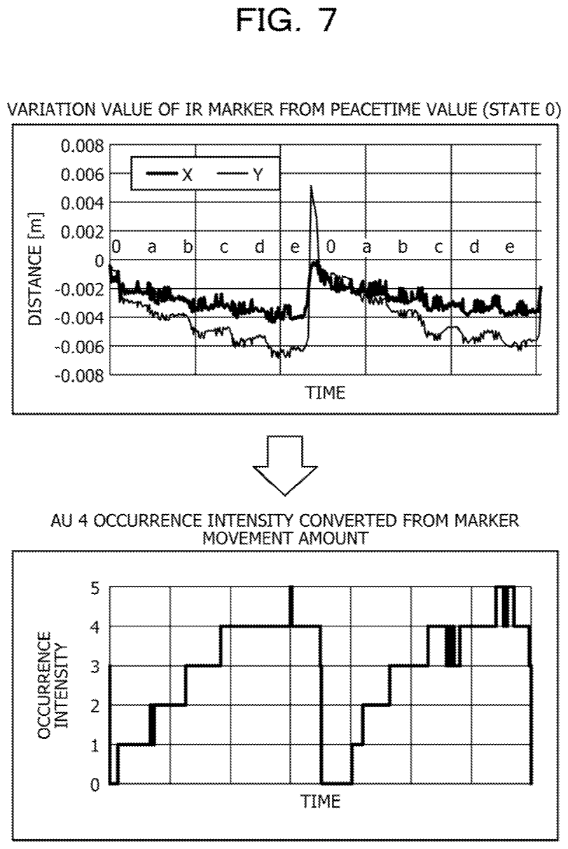

Furthermore, variation values of the distance between the marker 401 and the reference marker in the X direction and the Y direction are as indicated in FIG. 7. FIG. 7 is a diagram for explaining a method of determining an occurrence intensity. As illustrated in FIG. 7, the determination unit 15B can convert the variation value into the occurrence intensity. Note that the occurrence intensity may be quantized in five levels according to a facial action coding system (FACS), or may be defined as a continuous amount based on a variation amount.

Various rules may be considered as a rule for the determination unit 15B to convert the variation amount into the occurrence intensity. The determination unit 15B may perform conversion according to one predetermined rule, or may perform conversion according to a plurality of rules and adopt the one with the highest occurrence intensity.

For example, the determination unit 15B may in advance acquire the maximum variation amount, which is a variation amount when the subject changes the facial expression most, and may convert the occurrence intensity based on a ratio of the variation amount with respect to the maximum variation amount. Furthermore, the determination unit 15B may determine the maximum variation amount using data tagged by a coder with a traditional method. Furthermore, the determination unit 15B may linearly convert the variation amount into the occurrence intensity. Furthermore, the determination unit 15B may perform conversion using an approximation formula created by measuring a plurality of subjects in advance.

Furthermore, for example, the determination unit 15B may determine the occurrence intensity based on a motion vector of the first marker calculated based on a position preset as the determination criterion and the position of the first marker specified by the specification unit 15A. In this case, the determination unit 15B determines the occurrence intensity of the first AU based on a matching degree between the motion vector of the first marker and a defined vector defined in advance for the first AU. Furthermore, the determination unit 15B may correct a correspondence between the occurrence intensity and a magnitude of the vector using an existing AU estimation engine.

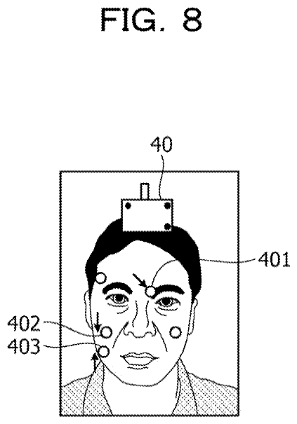

FIG. 8 is a diagram for explaining an example of the method of determining the occurrence intensity. For example, it is assumed that an AU 4 defined vector corresponding to the AU 4 is determined in advance as (−2 mm, −6 mm). At this time, the determination unit 15B calculates an inner product of the AU4 defined vector and the motion vector of the marker 401, and perform standardization with the magnitude of the AU 4 defined vector. Here, when the inner product matches the magnitude of the AU 4 defined vector, the determination unit 15B determines that the occurrence intensity of the AU 4 is five on the five-point scale. Meanwhile, when the inner product is half of the AU 4 defined vector, for example, the determination unit 15B determines that the occurrence intensity of the AU 4 is three on the five-point scale in a case of the linear conversion rule mentioned above.

Furthermore, for example, as illustrated in FIG. 8, it is assumed that a magnitude of an AU 11 vector corresponding to the AU 11 be determined as 3 mm in advance. At this time, when a variation amount of a distance between the markers 402 and 403 matches the magnitude of the AU 11 vector, the determination unit 15B determines that the occurrence intensity of the AU 11 is 5 on the five-point scale. Meanwhile, when the variation amount of the distance is a half of the AU 4 vector, for example, the determination unit 15B determines that the occurrence intensity of the AU 11 is three on the five-point scale in a case of the linear conversion rule mentioned above. In this manner, the determination unit 15B can determine the occurrence intensity, based on a change in a distance between the position of the first marker specified by the specification unit 15A and a position of a second marker.

The image processing unit 15C is a processing unit that processes a captured image into a training image. Only as an example, the image processing unit 15C performs processing such as extraction of a face region, normalization of an image size, or removal of a marker in an image, on the captured image 110 imaged by the imaging device 31.

As described with reference to FIG. 3, the image processing unit 15C performs face detection on the captured image 110 (S1). As a result, a face region 110A of 726 vertical pixels×726 horizontal pixels is detected from the captured image 110 of 1920 vertical pixels×1080 horizontal pixels. Then, the image processing unit 15C extracts a partial image corresponding to the face region 110A detected in the face detection from the captured image 110 (S2). As a result, an extracted face image 111 of 726 vertical pixels×726 horizontal pixels is obtained. Thereafter, the image processing unit 15C normalizes the extracted face image 111 of 726 vertical pixels×726 horizontal pixels into an image size of 512 vertical pixels×512 horizontal pixels corresponding to the input size of the machine learning model m (S3). As a result, a normalized face image 112 of 512 vertical pixels×512 horizontal pixels is obtained. Moreover, the image processing unit 15C deletes the markers from the normalized face image 112 (S4). As a result of these steps S1 to S4, the training face image 113 of 512 vertical pixels×512 horizontal pixels is obtained from the captured image 110 of 1920 vertical pixels×1080 horizontal pixels.

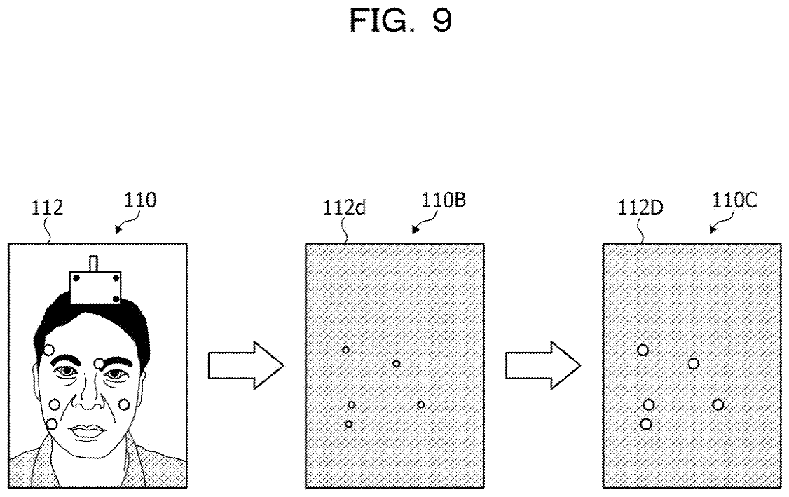

Such marker deletion will be supplementally described. Only as an example, it is possible to delete the marker using a mask image. FIG. 9 is a diagram for explaining an example of a method of creating the mask image. A reference 112 in FIG. 9 is an example of a normalized face image. First, the image processing unit 15C extracts a marker color that has been intentionally added in advance and defines the color as a representative color. Then, as indicated by a reference 112d illustrated in FIG. 9, the image processing unit 15C generates a region image with a color close to the representative color. Moreover, as indicated by a reference 112D illustrated in FIG. 9, the image processing unit 15C executes processing for contracting, expanding, or the like the region with the color close to the representative color and generates a mask image for marker deletion. Furthermore, accuracy of extracting the color of the marker may be improved by setting the color of the marker to a color that hardly exists as a color of a face.

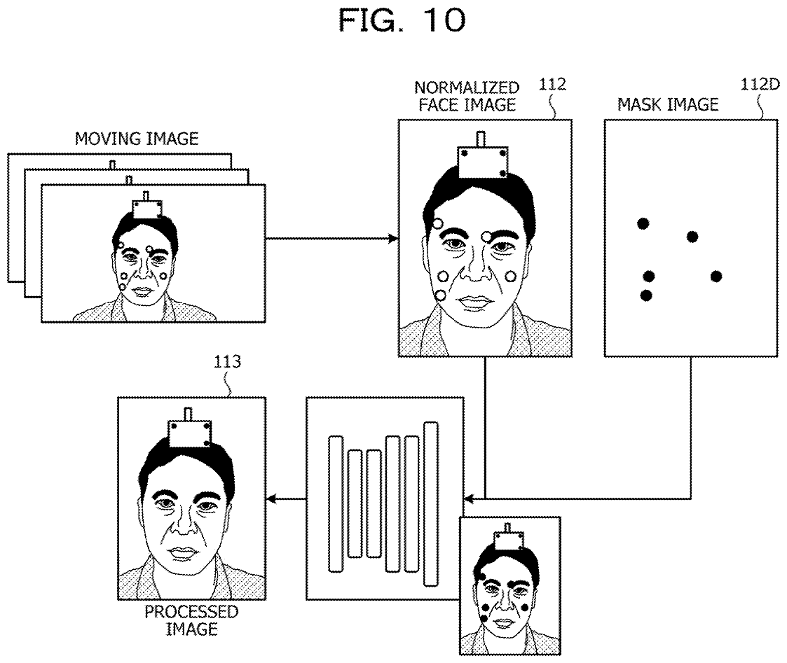

FIG. 10 is a diagram for explaining an example of a marker deletion method. As illustrated in FIG. 10, first, the image processing unit 15C applies a mask image to the normalized face image 112 generated from a still image acquired from a moving image. Moreover, the image processing unit 15C inputs the image to which the mask image is applied, for example, into a neural network and obtains the training face image 113 as a processed image. Note that the neural network is assumed to have been trained using an image of the subject with the mask, an image without the mask, or the like. Note that acquiring the still image from the moving image has an advantage that data in the middle of a facial expression change may be obtained and that a large volume of data may be obtained in a short time. Furthermore, the image processing unit 15C may use a generative multi-column convolutional neural network (GMCNN) or a generative adversarial networks (GAN) as the neural network.

Note that the method for deleting the marker by the image processing unit 15C is not limited to the above. For example, the image processing unit 15C may detect a position of a marker based on a predetermined marker shape and generate a mask image. Furthermore, a relative position of the IR camera 32 and the RGB camera 31 may be preliminary calibrated. In this case, the image processing unit 15C can detect the position of the marker from information of marker tracking by the IR camera 32.

Furthermore, the image processing unit 15C may adopt a different detection method depending on a marker. For example, for a marker above a nose, a movement is small and it is possible to easily recognize the shape. Therefore, the image processing unit 15C may detect the position through shape recognition. Furthermore, for a marker besides a mouth, a movement is large, and it is difficult to recognize the shape. Therefore, the image processing unit 15C may detect the position by a method of extracting the representative color.

Returning to the description of FIG. 5, the correction coefficient calculation unit 15D is a processing unit that calculates a correction coefficient used to correct a label to be attached to the training face image.

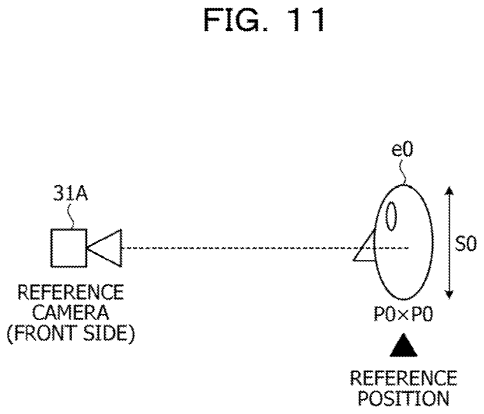

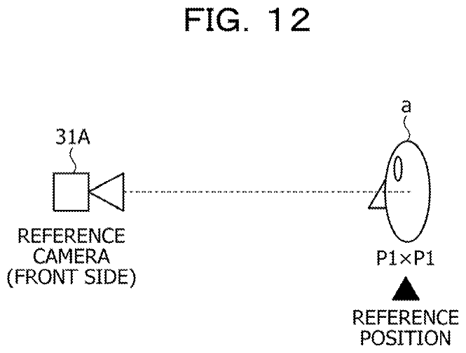

As one aspect, the correction coefficient calculation unit 15D calculates a “face size correction coefficient” to be multiplied by the label from an aspect of correcting the label according to the face size of the subject. FIGS. 11 and 12 are schematic diagrams illustrating an imaging example of the subject. In FIGS. 11 and 12, as an example of the imaging device 31, an RGB camera arranged in front of the face of the subject is illustrated as a reference camera 31A, and a situation is illustrated where both of a reference subject e0 and the subject a are imaged at a reference position. Note that, the “reference position” here indicates that a distance from the optical center of the reference camera 31A is L0.

As illustrated in FIG. 11, it is assumed that a face size on a captured image in a case where the reference subject e0 whose width and height of an actual face size are a reference size S0 is imaged by the reference camera 31A be a width P0 pixels×height P0 pixels. The “face size on the captured image” here corresponds to a size of the face region obtained by performing the face detection on the captured image. The face size P0 of the reference subject e0 on such a captured image can be acquired as a setting value by performing calibration in advance.

On the other hand, as illustrated in FIG. 12, when it is assumed that a face size on a captured image in a case where one subject a is imaged by the reference camera 31A be a width P1×height P1 pixels, a ratio of the face size on the captured image of the subject a with respect to the reference subject e0 can be calculated as a face size correction coefficient C1. For example, according to the example illustrated in FIG. 12, the correction coefficient calculation unit 15D can calculate the face size correction coefficient C1 as “P0/P1”.

By multiplying the label by such a face size correction coefficient C1, even in a case where the face size of the subject has an individual difference or the like, the label can be corrected according to the normalized image size of the captured image of the subject a. For example, a case is described where the same marker movement amount corresponding to an AU common to the subject a and the reference subject e0 is imaged. At this time, in a case where the face size of the subject a is larger than the face size of the reference subject e0, for example, in a case of “P1>P0”, the marker movement amount over the training face image of the subject a is smaller than the marker movement amount over the training face image of the reference subject e0 due to normalization processing. Even in such a case, by multiplying a label attached to the training face image of the subject a by the face size correction coefficient C1=(P0/P1)<1, the label can be corrected to be smaller.

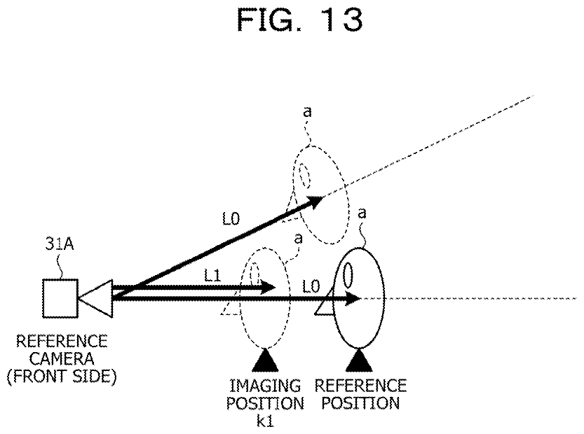

As another aspect, the correction coefficient calculation unit 15D calculates a “position correction coefficient” to be multiplied by the label from an aspect of correcting the label according to the head position of the subject. FIG. 13 is a schematic diagram illustrating an imaging example of the subject. In FIG. 13, as an example of the imaging device 31, an RGB camera arranged in front of the face of the subject a is illustrated as the reference camera 31A, and a situation where the subject a is imaged at different positions including the reference position is illustrated.

As illustrated in FIG. 13, in a case where the subject a is imaged at an imaging position k1, a ratio of the imaging position k1 with respect to the reference position can be calculated as a position correction coefficient C2. For example, since the measurement device 32 can measure not only the position of the marker but also a 3D position of the head of the subject a through motion capturing, such a 3D position of the head can be referred from the measurement result 120. Therefore, a distance L1 between the reference camera 31A and the subject a can be calculated based on the 3D position of the head of the subject a obtained as the measurement result 120. The position correction coefficient C2 can be calculated as “L1/L0” from the distance L1 corresponding to such an imaging position k1 and a distance L0 corresponding to the reference position.

By multiplying the label by such a position correction coefficient C2, even in a case where the imaging position of the subject a varies, the label can be corrected according to the normalized image size of the captured image of the subject a. For example, a case is described where the same marker movement amount corresponding to an AU common to the reference position and the imaging position k1 is imaged. At this time, in a case where the distance L1 corresponding to the imaging position k1 is smaller than the distance L0 corresponding to the reference position, for example, in a case of L1<L0, the marker movement amount over the training face image of the imaging position k1 is smaller than the marker movement amount over the training face image at the reference position due to the normalization processing. Even in such a case, by multiplying the position correction coefficient C2=(L1/L0)<1 by the label to be attached to the training face image of the imaging position k1, the label can be corrected to be smaller.

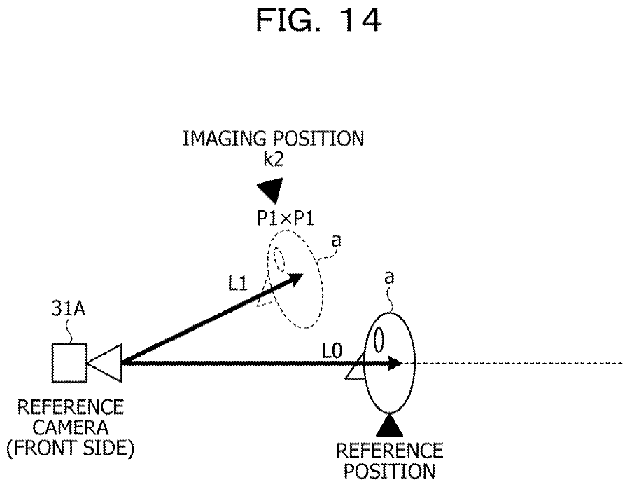

As a further aspect, the correction coefficient calculation unit 15D can also calculate an “integrated correction coefficient C3” that is obtained by integrating the “face size correction coefficient C1” described above and the “position correction coefficient C2” described above. FIG. 14 is a schematic diagram illustrating an imaging example of the subject. In FIG. 14, as an example of the imaging device 31, an RGB camera arranged in front of the face of the subject a is illustrated as the reference camera 31A, and a situation where the subject a is imaged at different positions including the reference position is illustrated.

As illustrated in FIG. 14, in a case where the subject a is imaged at an imaging position k2, the correction coefficient calculation unit 15D can calculate the distance L1 from the optical center of the reference camera 31A, based on the 3D position of the head of the subject a obtained as the measurement result 120. According to such a distance L1 from the optical center of the reference camera 31A, the correction coefficient calculation unit 15D can calculate the position correction coefficient C2 as “L1/L0”.

Moreover, the correction coefficient calculation unit 15D can acquire a face size P1 of the subject a on the captured image obtained as a result of the face detection on the captured image of the subject a, for example, the width P1 pixels×the height P1 pixels. Based on such a face size P1 of the subject a on the captured image, the correction coefficient calculation unit 15D can calculate an estimated value P1′ of the face size of the subject a at the reference position. For example, from a ratio of the reference position and the imaging position k2, P1′ can be calculated as “P1/(L1/L0)” according to the derivation of the following formula (1). Moreover, the correction coefficient calculation unit 15D can calculate the face size correction coefficient C1 as “P0/P1” from a ratio of the face size at the reference position between the subject a and the reference subject e0.

P1′=P1×(L0/L1)=P1/(L1/L0) (1)

By integrating the position correction coefficient C2 and the face size correction coefficient C1, the correction coefficient calculation unit 15D calculates the integrated correction coefficient C3. For example, the integrated correction coefficient C3 can be calculated as “(P0/P1)×(L1/L0)” according to derivation of the following formula (2).

C3=P0/P1′=P0÷{P1/(L1/L0)}=P0×(1/P1)×(L1/L0)=(P0/P1)×(L1/L0) (2)

Returning to the description of FIG. 5, the correction unit 15E is a processing unit that corrects a label. Only as an example, as indicated in the following formula (3), the correction unit 15E can realize correction of the label by multiplying the AU occurrence intensity determined by the determination unit 15B, for example, the label by the integrated correction coefficient C3 calculated by the correction coefficient calculation unit 15D. Note that, here, an example has been described where the label is multiplied by the integrated correction coefficient C3. However, this is merely an example, and the label may be multiplied by the face size correction coefficient C1 or the position correction coefficient C2 as indicated in the formulas (4) and (5).

Example 1: corrected label=Label×C3=Label×(P0/P1)×(L1/L0) (3)

Example 2: corrected label=Label×C1=Label×(P0/P1) (4)

Example 3: corrected label=Label×C2=Label×(L1/L0) (5)

The generation unit 15F is a processing unit that generates training data. Only as an example, the generation unit 15F generates training data for machine learning by adding the label corrected by the correction unit 15E to the training face image generated by the image processing unit 15C. A dataset of the training data can be obtained by performing such training data generation in units of captured image imaged by the imaging device 31.

For example, when the machine learning device 50 performs machine learning using the dataset of the training data, the machine learning device 50 may perform machine learning as adding the training data generated by the training data generation device 10 to existing training data.

Only as an example, the training data can be used for machine learning of an estimation model for estimating an occurring AU, using an image as an input. Furthermore, the estimation model may be a model specialized for each AU. In a case where the estimation model is specialized for a specific AU, the training data generation device 10 may change the generated training data to training data using only information regarding the specific AU as a training label. For example, the training data generation device 10 can delete information regarding another AU for an image in which the another AU different from the specific AU occurs and add information indicating that the specific AU does not occur as a training label.

According to the present embodiment, it is possible to estimate needed training data. Enormous calculation costs are commonly needed to perform machine learning. The calculation costs include time and a usage amount of a graphics processing unit (GPU) or the like.

As quality and quantity of the dataset are improved, accuracy of a model obtained by the machine learning improves. Therefore, the calculation costs may be reduced if it is possible to roughly estimate quality and quantity of a dataset needed for target accuracy in advance. Here, for example, the quality of the dataset indicates a deletion rate and deletion accuracy of markers. Furthermore, for example, the quantity of the dataset indicates the number of datasets and the number of subjects.

There are combinations with high correlation with each other among the AU combinations. Accordingly, it is considered that estimation made for a certain AU may be applied to another AU highly correlated with the AU. For example, a correlation between an AU 18 and an AU 22 is known to be high, and the corresponding markers may be common. Accordingly, if it is possible to estimate the quality and the quantity of the dataset to the extent that estimation accuracy of the AU 18 reaches a target, it becomes possible to roughly estimate the quality and the quantity of the dataset to the extent that estimation accuracy of the AU 22 reaches the target.

The machine learning model M generated by the machine learning device 50 may be provided to an estimation device (not illustrated) that estimates an AU occurrence intensity. The estimation device actually performs estimation using the machine learning model M generated by the machine learning device 50. The estimation device may acquire an image in which a face of a person is imaged and an occurrence intensity of each AU is unknown, and may input the acquired image to the machine learning model M, whereby the AU occurrence intensity output by the machine learning model M may be output to any output destination as an AU estimation result. Only as an example, such an output destination may be a device, a program, a service, or the like that estimates facial expressions using the AU occurrence intensity or calculates a comprehension or satisfaction degree.

<Processing Flow>

Next, a flow of processing of the training data generation device 10 will be described. Here, after describing (1) overall processing executed by the training data generation device 10, (2) determination processing, (3) image process processing, and (4) correction processing will be described.

(1) Overall Processing

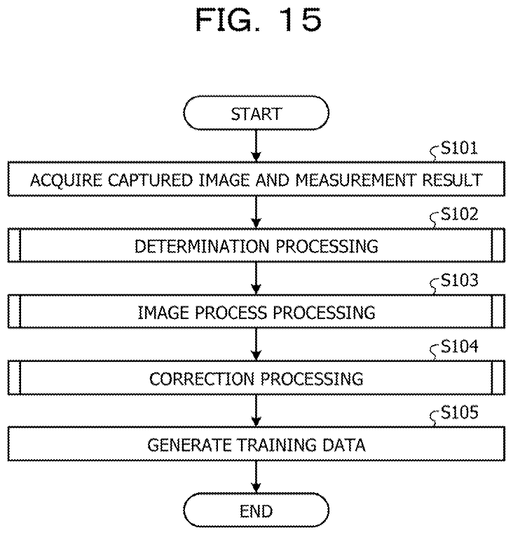

FIG. 15 is a flowchart illustrating a procedure of the overall processing. As illustrated in FIG. 15, the captured image imaged by the imaging device 31 and the measurement result measured by the measurement device 32 are acquired (step S101).

Subsequently, the specification unit 15A and the determination unit 15B execute “determination processing” for determining an AU occurrence intensity, based on the captured image and the measurement result acquired in step S101 (step S102).

Then, the image processing unit 15C executes “image process processing” for processing the captured image acquired in step S101 to a training image (step S103).

Thereafter, the correction coefficient calculation unit 15D and the correction unit 15E execute “correction processing” for correcting the AU determination intensity determined in step S102, for example, a label (step S104).

Then, the generation unit 15F generates training data by attaching the label corrected in step S104 to the training face image generated in step S103 (step S105) and end the processing.

Note that the processing in step S104 illustrated in FIG. 15 can be executed at any timing after the extracted face image is normalized. For example, the processing in step S104 may be executed before the marker is deleted, and the timing is not necessarily limited to the timing after the marker is deleted.

(2) Determination Processing

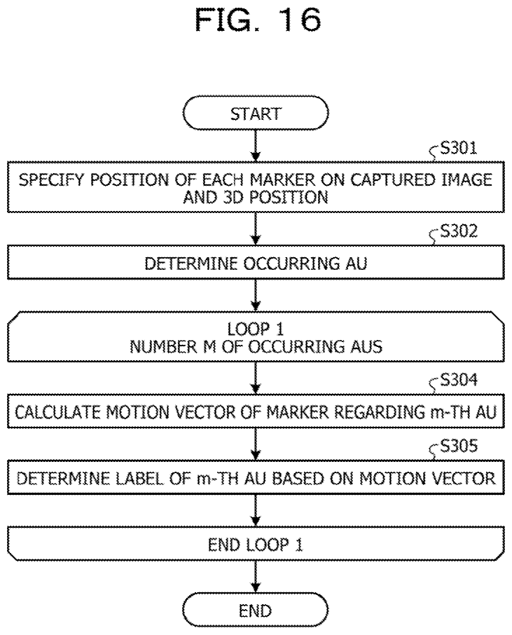

FIG. 16 is a flowchart illustrating a procedure of the determination processing. As illustrated in FIG. 16, the specification unit 15A specifies a position of a marker included in the captured image acquired in step S101 based on the measurement result acquired in step S101 (step S301).

Then, the determination unit 15B determines an occurring AU occurred in the captured image, based on the AU determination criterion included in the AU information 13A and the positions of the plurality of markers specified in step S301 (step S302).

Thereafter, the determination unit 15B executes loop processing 1 for repeating the processing in steps S304 and S305, for the number of times corresponding to the number M of occurring AUs determined in step S302.

For example, the determination unit 15B calculates a motion vector of the marker, based on a position of a marker assigned for estimation of an m-th occurring AU and the reference position, among the positions of the markers specified in step S301 (step S304). Then, the determination unit 15B determines am occurrence intensity of the m-th occurring AU based on the motion vector, for example, a label (step S305).

By repeating such loop processing 1, the occurrence intensity can be determined for each occurring AU. Note that, in the flowchart illustrated in FIG. 16, an example has been described in which the processing in steps S304 and S305 is repeatedly executed. However, the embodiment is not limited to this, and the processing may be executed in parallel for each occurring AU.

(3) Image Process Processing

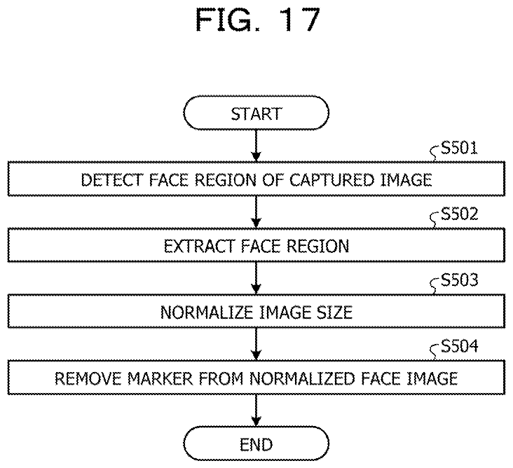

FIG. 17 is a flowchart illustrating a procedure of the image process processing. As illustrated in FIG. 17, the image processing unit 15C performs face detection on the captured image acquired in step S101 (step S501). Then, the image processing unit 15C extracts a partial image corresponding to a face region detected in step S501 from the captured image (step S502).

Thereafter, the image processing unit 15C normalizes the extracted face image extracted in step S502 into an image size corresponding to the input size of the machine learning model m (step S503). Thereafter, the image processing unit 15C deletes the marker from the normalized face image normalized in step S503 (step S504) and ends the processing.

As a result of the processing in these steps S501 to S504, the training face image is obtained from the captured image.

(4) Correction Processing

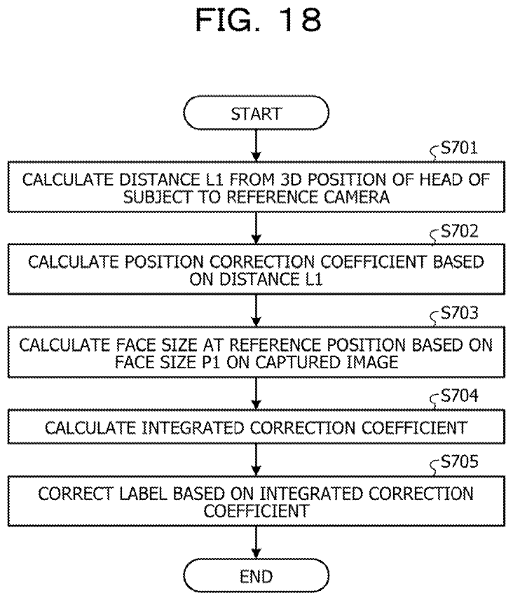

FIG. 18 is a flowchart illustrating a procedure of the correction processing. As illustrated in FIG. 18, the correction coefficient calculation unit 15D calculates a distance L1 from the reference camera 31A to the head of the subject, based on the 3D position of the head of the subject obtained as the measurement result acquired in step 5101 (step S701).

Subsequently, the correction coefficient calculation unit 15D calculates a position correction coefficient according to the distance L1 calculated in step S701 (step S702). Moreover, the correction coefficient calculation unit 15D calculates an estimated value P1′ of the face size of the subject at the reference position, based on the face size of the subject on the captured image obtained as the face detection on the captured image of the subject (step S703).

Thereafter, the correction coefficient calculation unit 15D calculates an integrated correction coefficient, from the estimated value P1′ of the face size of the subject at the reference position and a ratio of the face size at the reference position between the subject and the reference subject (step S704).

Then, the correction unit 15E corrects a label by multiplying the AU occurrence intensity determined in step S304, for example, the label, by the integrated correction coefficient calculated in step S704 (step S705) and ends the processing.

<One Aspect of Effects>

As described above, the training data generation device 10 according to the present embodiment corrects the label of the AU occurrence intensity corresponding to the marker movement amount measured by the measurement device 32, based on the distance between the optical center of the imaging device 31 and the head of the subject or the face size on the captured image. As a result, it is possible to correct the label in accordance with the movement of the marker over the face image that is fluctuated by processing such as extraction of a face region or normalization of an image size. Therefore, according to the training data generation device 10 according to the present embodiment, it is possible to prevent generation of training data in which a correspondence relationship between the movement of the marker over the face image and the label is distorted.

### Second Embodiment

Incidentally, while the embodiment relating to the disclosed device has been described above, the embodiment may be carried out in a variety of different modes apart from the embodiment described above. Thus, hereinafter, another embodiment included in the present disclosure will be described.

### Application Example of Imaging Device 31

In the first embodiment described above, as an example of the imaging device 31, the RGB camera arranged in front of the face of the subject is illustrated as the reference camera 31A. However, RGB cameras may be arranged in addition to the reference camera 31A. For example, the imaging device 31 may be implemented as a camera unit including a plurality of RGB cameras including a reference camera.

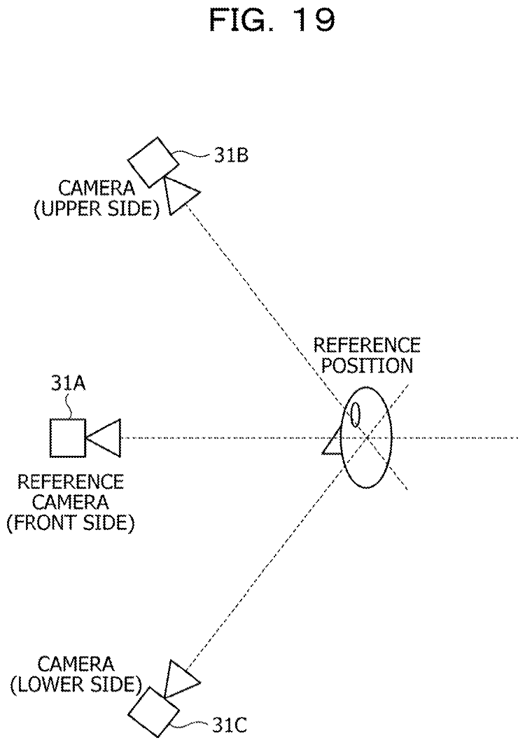

FIG. 19 is a schematic diagram illustrating an example of the camera unit. As illustrated in FIG. 19, the imaging device 31 may be implemented as a camera unit including three RGB cameras that are the reference camera 31A, an upper camera 31B, and a lower camera 31C.

For example, the reference camera 31A is arranged on the front side of the subject, that is, at an eye-level camera position with a horizontal camera angle. Furthermore, the upper camera 31B is arranged at a high angle on the front side and above the face of the subject. Moreover, the lower camera 31C is arranged at a low angle on the front side and below the face of the subject.

With such a camera unit, a change in a facial expression expressed by the subject can be imaged at a plurality of camera angles. Therefore, it is possible to generate a plurality of training face images of which directions of the face of the subject for the same AU are different.

Note that the camera positions illustrated in FIG. 19 are merely examples, and it is not necessary to arrange the camera in front of the face of the subject, and the cameras may be arranged to face the left front, the left side, the right front, the right side, or the like of the face of the subject. Furthermore, the number of cameras illustrated in FIG. 19 is merely an example, and any number of cameras may be arranged.

<One Aspect of Problem When Camera Unit Is Applied>

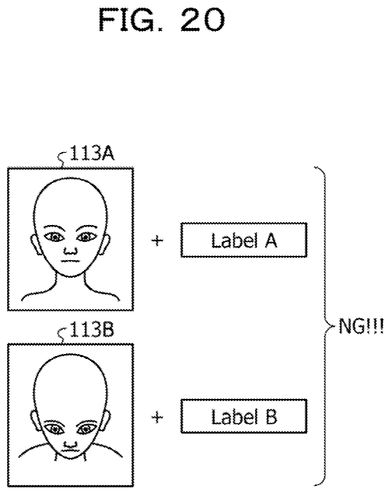

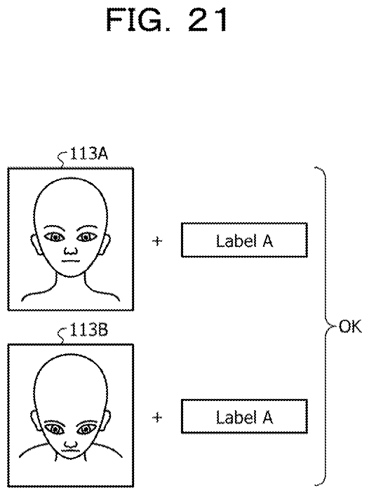

FIGS. 20 and 21 are diagrams illustrating a training data generation case. In FIGS. 20 and 21, a training image 113A generated from a captured image imaged by the reference camera 31A and a training image 113B generated from a captured image imaged by the upper camera 31B are illustrated. Note that it is assumed that the training images 113A and 113B illustrated in FIGS. 20 and 21 be generated from captured images of which the change in the facial expression of the subject is synchronized.

As illustrated in FIG. 20, a label A is attached to the training image 113A, and a label B is attached to the training image 113B. In this case, different labels are attached to the same AU imaged at different camera angles. As a result, in a case where the directions of the face of the subject to be imaged vary, this will be a factor in generating the machine learning model M that outputs different labels even with the same AU.

On the other hand, as illustrated in FIG. 21, the label A is attached to the training image 113A, and the label A is also attached to the training image 113B. In this case, a single label can be attached to the same AUs imaged at different camera angles. As a result, even in a case where the directions of the face of the subject to be imaged vary, it is possible to generate the machine learning model M that outputs a single label.

Therefore, in a case where the same AU is imaged at different camera angles, it is preferable to attach the single label to the training face images respectively generated from the captured images imaged by the reference camera 31A, the upper camera 31B, and the lower camera 31C.

At this time, in order to maintain a correspondence relationship between the movement of the marker over the face image and the label, label value (numerical value) conversion is more advantageous than image conversion, in terms of a calculation amount or the like. However, if the label is corrected for each captured image imaged by each of the plurality of cameras, different labels are attached for the respective cameras. Therefore, there is an aspect in which it is difficult to attach the single label.

<One Aspect of Problem Solving Approach>

From such an aspect, the training data generation device 10 can correct an image size of the training face image according to the label, instead of correcting the label. At this time, if image sizes of all the normalized face images corresponding to all the cameras included in the camera unit can be corrected, image sizes of some normalized face images corresponding to some cameras, for example, a camera group other than the reference camera can be corrected.

Such a method for calculating a correction coefficient of the image size will be described. Only as an example, it is assumed to identify cameras by generalizing the number of cameras included in a camera unit to N, setting a camera number of the reference camera 31A to zero, setting a camera number of the upper camera 31B to one, and attaching the camera number after an underline.

Hereinafter, only as an example, a method for calculating the correction coefficient used to correct the image size of the normalized face image corresponding to the upper camera 31B is described while setting an index used to identify the camera number to n=1. However, the camera is not limited to the upper camera 31B. For example, it is needless to say that the correction coefficient of the image size can be similarly calculated in a case where the index is n=0 or n is equal to or more than two.

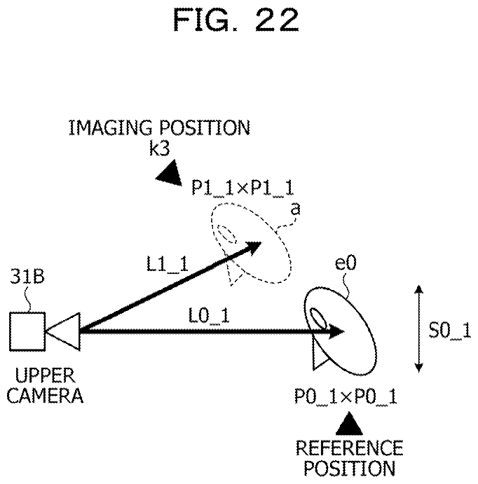

FIG. 22 is a schematic diagram illustrating an imaging example of the subject. In FIG. 22, the upper camera 31B is excerpted and illustrated. As illustrated in FIG. 22, in a case where the subject a is imaged at an imaging position k3, the correction coefficient calculation unit 15D can calculate a distance L1_1 from the optical center of the upper camera 31B to the face of the subject a, based on the 3D position of the head of the subject a obtained as the measurement result 120. From a ratio between such a distance L1_1 and a distance L0_1 corresponding to the reference position, the correction coefficient calculation unit 15D can calculate a position correction coefficient of the image size as “L1_1/L0_1”.

Moreover, the correction coefficient calculation unit 15D can acquire a face size P1_1, for example, a width P1_1 pixels×a height P1_1 pixels of the subject a on a captured image obtained as a result of the face detection on the captured image of the subject a. Based on such a face size P1 of the subject a on the captured image, the correction coefficient calculation unit 15D can calculate an estimated value P1_1′ of the face size of the subject a at the reference position. For example, P1_1′ can be calculated as “P1_1/(L1_1/L0_1)” from the ratio between the reference position and the imaging position k3.

Then, the correction coefficient calculation unit 15D calculates an integrated correction coefficient K of the image size as “(P1_1/P0_1)×(L0_1/L1_1)”, from the estimated value P1_1′ of the face size of the subject at the reference position and a ratio between the face sizes at the reference position of the subject a and the reference subject e0.

Thereafter, the correction unit 15E changes the image size of the normalized face image generated from the captured image of the upper camera 31B, according to the integrated correction coefficient K=(P1_1/P0_1)×(L0_1/L1_1) of the image size. For example, the image size of the normalized face image is changed to an image size obtained by multiplying the integrated correction coefficient K=(P1_1/P0_1)×(L0_1/L1_1) of the image size by the number of pixels in each of the width and the height of the normalized face image generated from the captured image of the upper camera 31B. Through such a change in the image size of the normalized face image, a corrected face image can be obtained.

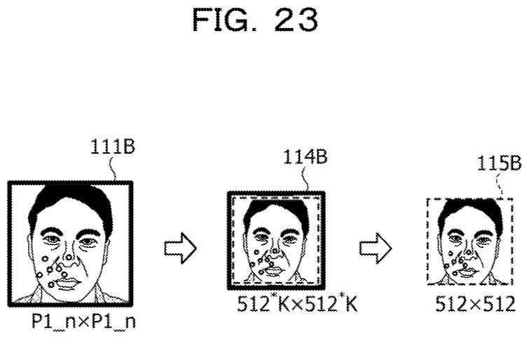

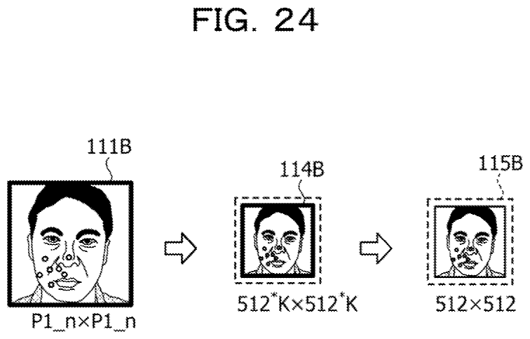

FIGS. 23 and 24 are diagrams illustrating an example of the corrected face image. In FIGS. 23 and 24, an extracted face image 111B generated from the captured image of the upper camera 31B and a corrected face image 114B obtained by changing the image size of the normalized face image obtained by normalizing the extracted face image 111B is changed based on the integrated correction coefficient K are illustrated. Moreover, in FIG. 23, the corrected face image 114B in a case where the integrated correction coefficient K of the image size is equal to or more than one is illustrated, and in FIG. 24, the corrected face image 114B in a case where the integrated correction coefficient K of the image size is less than one is illustrated. Moreover, in FIGS. 23 and 24, an image size corresponding to 512 vertical pixels×512 horizontal pixels that is an example of the input size of the machine learning model m is indicated by a dashed line.

As illustrated in FIG. 23, in a case where the integrated correction coefficient K of the image size is equal to or more than one, the image size of the corrected face image 114B is larger than 512 vertical pixels×512 horizontal pixels that is the input size of the machine learning model m. In this case, by re-extracting a region of 512 vertical pixels×512 horizontal pixels corresponding to the input size of the machine learning model m from the corrected face image 114B, a training face image 115B is generated. Note that, for convenience of explanation, in FIG. 23, an example is illustrated in which a face region is detected as setting a margin portion included in a face region detected by a face detection engine to zero%. However, by setting the margin portion to a%, for example, about 10%, it is possible to prevent a face portion from being missed from the training face image 115B that has been re-extracted.

On the other hand, as illustrated in FIG. 24, in a case where the integrated correction coefficient K of the image size is less than one, the image size of the corrected face image 114B is smaller than 512 vertical pixels×512 horizontal pixels that is the input size of the machine learning model m. In this case, by adding a margin portion lacked in 512 vertical pixels×512 horizontal pixels corresponding to the input size of the machine learning model m to the corrected face image 114B, the training face image 1158 is generated.

Since the correction made by changing the image size as described above has an aspect in which a calculation amount is larger than label correction, it is possible to perform label correction on a normalized image generated from a captured image of some cameras, for example, the reference camera 31A without performing image correction.

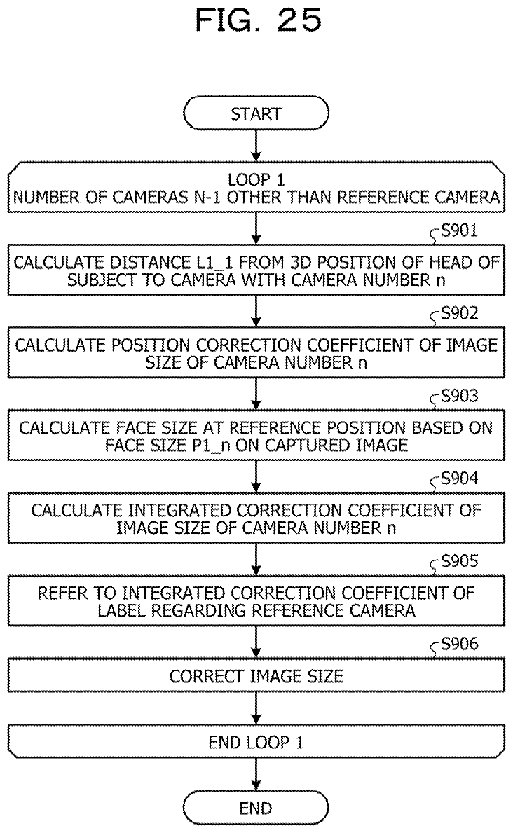

In this case, it is sufficient that, while the correction processing illustrated in FIG. 18 is applied to the normalized face image corresponding to the reference camera 31A, the correction processing corresponding to FIG. 25 be applied to the normalized face image corresponding to the cameras other than the reference camera 31A.

FIG. 25 is a flowchart illustrating a procedure of the correction processing applied to the cameras other than the reference camera. As illustrated in FIG. 25, the correction coefficient calculation unit 15D executes loop processing 1 for repeating processing from step S901 to step S907, for the number of times corresponding to the number of cameras N−1 other than the reference camera 31A.

For example, the correction coefficient calculation unit 15D calculates a distance L1_n from a camera 31n with a camera number n to the head of the subject, based on the 3D position of the head of the subject obtained as the measurement result measured in step S101 (step S901).

Subsequently, the correction coefficient calculation unit 15D calculates a position correction coefficient “L1_n/L0_n” of an image size of the camera number n based on the distance L1_n calculated in step S901 and a distance L0_n corresponding to the reference position (step S902).

Then, the correction coefficient calculation unit 15D calculates an estimated value “P1_n′=P1_n/(L1_n/L0_n)” of the face size of the subject at the reference position, based on a face size of the subject on a captured image obtained as a result of face detection on a captured image with the camera number n (step S903).

Subsequently, the correction coefficient calculation unit 15D calculates an integrated correction coefficient “K=(P1_n/P0_n)×(L0_n/L1_n)” of the image size of the camera number n, from the estimated value P1_n′ of the face size of the subject at the reference position and the ratio of the face size at the reference position between the subject a and the reference subject e0 (step S904).

Then, the correction coefficient calculation unit 15D refers to an integrated correction coefficient of a label of the reference camera 31A, for example, the integrated correction coefficient C3 calculated in step S704 illustrated in FIG. 18 (step S905).

Thereafter, the correction unit 15E changes an image size of a normalized face image based on the integrated correction coefficient K of the image size of the camera number n calculated in step S904 and the integrated correction coefficient of the label of the reference camera 31A referred in step S905 (step S906). For example, the image size of the normalized face image is changed to (P1_n/P0_n)×(L0_n/L1_n)×(P0_0/P1_0)×(L1_0/L0_0) times. As a result, a training face image of the camera number n is obtained.

The following label is attached to the training face image of the camera number n obtained in this way in step S906, at a stage in step S105 illustrated in FIG. 15. For example, a corrected label attached to the training face image generated from the captured image of the reference camera 31A (with no image size change), for example, the same label as Label×(P0/P1)×(L1/L0) is attached to the training face image of the camera number n. As a result, it is possible to attach a single label to the training face images of all the cameras.

### Application Example

Note that, in the first embodiment described above, a case has been described where each of the training data generation device 10 and the machine learning device 50 is made as an individual device. However, the training data generation device 10 may have functions of the machine learning device 50.

Note that, in the embodiment described above, the descriptions have been given on the assumption that the determination unit 15B determines the AU occurrence intensity based on the marker movement amount. On the other hand, the fact that the marker has not moved may also be a determination criterion of the occurrence intensity by the determination unit 15B.

Furthermore, an easily-detectable color may be arranged around the marker. For example, a round green adhesive sticker on which an IR marker is placed at the center may be attached to the subject. In this case, the training data generation device 10 can detect the round green region from the captured image, and delete the region together with the IR marker.

Pieces of information including the processing procedure, control procedure, specific name, and various types of data and parameters described above or illustrated in the drawings may be optionally modified unless otherwise noted. Furthermore, the specific examples, distributions, numerical values, and the like described in the embodiments are merely examples, and may be changed in any ways.

Furthermore, each component of each device illustrated in the drawings is functionally conceptual and does not necessarily have to be physically configured as illustrated in the drawings. For example, specific forms of distribution and integration of each device are not limited to those illustrated in the drawings. For example, all or a part of the devices may be configured by being functionally or physically distributed or integrated in any units according to various types of loads, usage situations, or the like. Moreover, all or any part of individual processing functions performed in each device may be implemented by a central processing unit (CPU) and a program analyzed and executed by the CPU, or may be implemented as hardware by wired logic.

<Hardware>

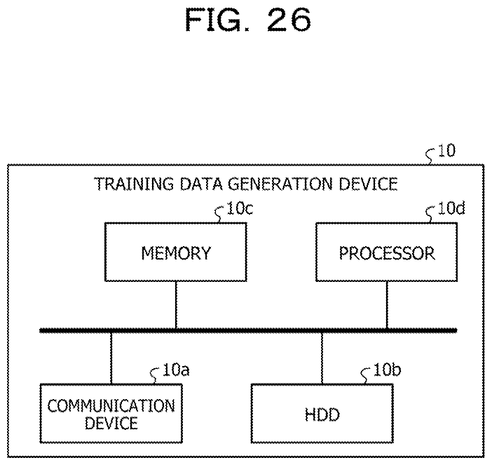

Next, a hardware configuration example of the computer described in the first and second embodiments will be described. FIG. 26 is a diagram for explaining the hardware configuration example. As illustrated in FIG. 26, the training data generation device 10 includes a communication device 10a, a hard disk drive (HDD) 10b, a memory 10c, and a processor 10d. Furthermore, each of the units illustrated in FIG. 26 are mutually coupled by a bus or the like.

The communication device 10a is a network interface card or the like, and communicates with another server. The HDD 10b stores a program that activates the functions illustrated in FIG. 5, a database (DB), or the like.

The processor 10d reads a program that executes processing similar to the processing of the processing unit illustrated in FIG. 5, from the HDD 10b or the like, and loads the read program into the memory 10c, thereby operating a process that executes the function described with reference to FIG. 5 or the like. For example, this process performs functions similar to those of the processing unit included in the training data generation device 10. For example, the processor 10d reads programs having similar functions to the specification unit 15A, the determination unit 15B, the image processing unit 15C, the correction coefficient calculation unit 15D, the correction unit 15E, the generation unit 15F, or the like from the HDD 10b or the like. Then, the processor 10d executes processes for executing similar processing to the specification unit 15A, the determination unit 15B, the image processing unit 15C, the correction coefficient calculation unit 15D, the correction unit 15E, the generation unit 15F, or the like.

In this way, the training data generation device 10 operates as an information processing device that performs the training data generation method, by reading and executing the programs. Furthermore, the training data generation device 10 reads the program described above from a recording medium by a medium reading device and executes the read program described above so as to implement the functions similar to the embodiments described above. Note that the program in the other embodiments is not limited to be executed by the training data generation device 10. For example, the embodiment may be similarly applied also to a case where another computer or server executes the program, or a case where such a computer and server cooperatively execute the program.

The program described above may be distributed via a network such as the Internet. Furthermore, the program described above can be executed by being recorded in any recording medium and read from the recording medium by the computer. For example, the recoding medium may be implemented by a hard disk, a flexible disk (FD), a CD-ROM, a magneto-optical disk (MO), a digital versatile disc (DVD), or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable storage medium storing a model training program that causes at least one computer to execute a process, the process comprising:
acquiring a plurality of images which include a face of a person, the plurality of images including a marker;
changing an image size of the plurality of images to first size;
specifying a position of the marker included in the changed plurality of images for each of the changed plurality of images;
generating a label for each of the changed plurality of images based on difference between the position of the marker included in each of the changed plurality of images and first position of the marker included in a first image of the changed plurality of images, the difference corresponding to a degree of movement of a facial part that forms facial expression of the face;
correcting the generated label based on relationship between each of the changed plurality of images and a second image of the changed plurality of images;
generating training data by attaching the corrected label to the changed plurality of images; and
training, by using the training data, a machine learning model that outputs a degree of movement of a facial part of third image by inputting the third image.

2. The non-transitory computer-readable recording medium according to claim 1, wherein
the correcting includes correcting the generated label based on a ratio of a pixel size of each face of the faces to a pixel size of the face of the person imaged in the second image.

3. The non-transitory computer-readable recording medium according to claim 1, wherein
the correcting includes correcting the generated label based on a ratio of a first distance to a second distance, the first distance being a distance between the camera and each face of the faces, the second distance being a distance between the camera and the face of the person imaged in the second image.

4. The non-transitory computer-readable recording medium according to claim 1, wherein the process further comprising
acquiring a second plurality of images from a second camera, each of the second plurality of images including the face of the person included in each of the plurality of images, and
wherein the generating training data includes attaching the corrected label of a fourth image of the changed plurality of images to a fifth image of the changed second plurality of images, the fifth image including the face of the person included in the fourth image.

5. The non-transitory computer-readable recording medium according to claim 4, wherein the generating the training data includes:
changing a size of the fifth image to a second size, the second size being a size obtained by correcting the first size by the relationship;
extracting a region that corresponds to the face from the changed fifth image so that a size of the region becomes an input size of the machine learning model when the size of the changed fifth image is more than the input size; and
adding a margin that is lacked for the input size to the changed fifth image so that the size of the fifth image becomes the input size when the size of the changed fifth image is less than the input size.

6. The non-transitory computer-readable recording medium according to claim 4, wherein
a camera angle of the camera is a horizontal angle, and
a camera angle of the second camera is other than the horizontal angle.

7. The non-transitory computer-readable recording medium according to claim 1, wherein
the training includes training by using the changed plurality of images as an explanatory variable and the corrected label as variable.

8. A model training method for a computer to execute a process comprising:
acquiring a plurality of images which include a face of a person, the plurality of images including a marker;
changing an image size of the plurality of images to first size;
specifying a position of the marker included in the changed plurality of images for each of the changed plurality of images;
generating a label for each of the changed plurality of images based on difference between the position of the marker included in each of the changed plurality of images and first position of the marker included in a first image of the changed plurality of images, the difference corresponding to a degree of movement of a facial part that forms facial expression of the face;
correcting the generated label based on relationship between each of the changed plurality of images and a second image of the changed plurality of images;
generating training data by attaching the corrected label to the changed plurality of images; and
training, by using the training data, a machine learning model that outputs a degree of movement of a facial part of third image by inputting the third image.

9. The model training method according to claim 8, wherein
the correcting includes correcting the generated label based on a ratio of a pixel size of each face of the faces to a pixel size of the face of the person imaged in the second image.

10. The model training method according to claim 8, wherein
the correcting includes correcting the generated label based on a ratio of a first distance to a second distance, the first distance being a distance between the camera and each face of the faces, the second distance being a distance between the camera and the face of the person imaged in the second image.

11. A model training device comprising:
one or more memories; and
one or more processors coupled to the one or more memories and the one or more processors configured to:
acquire a plurality of images which include a face of a person, the plurality of images including a marker,
change an image size of the plurality of images to first size,
specify a position of the marker included in the changed plurality of images for each of the changed plurality of images,
generate a label for each of the changed plurality of images based on difference between the position of the marker included in each of the changed plurality of images and first position of the marker included in a first image of the changed plurality of images, the difference corresponding to a degree of movement of a facial part that forms facial expression of the face,
correct the generated label based on relationship between each of the changed plurality of images and a second image of the changed plurality of images,
generate training data by attaching the corrected label to the changed plurality of images, and
train, by using the training data, a machine learning model that outputs a degree of movement of a facial part of third image by inputting the third image.

12. The model training device according to claim 11, wherein the one or more processors are further configured to
correct the generated label based on a ratio of a pixel size of each face of the faces to a pixel size of the face of the person imaged in the second image.

13. The model training device according to claim 11, wherein the one or more processors are further configured to
correct the generated label based on a ratio of a first distance to a second distance, the first distance being a distance between the camera and each face of the faces, the second distance being a distance between the camera and the face of the person imaged in the second image.
